(19) United States
(12) Patent Application Publication
(10) Pub. No.: US 2022/0170483 A1
(43) Pub. Date: Jun. 2, 2022

(54) Micro Water Pump

(71) Applicant: AAC Microtech (Changzhou) Co., Ltd., Changzhou City (CN)

(72) Inventors: Detao Xu, Shenzhen (CN); Qi Zhang, Shenzhen (CN)

(21) Appl. No.: 17/535,646

(22) Filed: Nov. 25, 2021

(30) Foreign Application Priority Data
Nov. 27, 2020 (CN) 202022809338.5

(51) Int. Cl. F04D 29/62; F04D 29/42; F04D 13/06

(52) U.S. Cl. CPC F04D 29/628; F04D 13/0693; F04D 29/426

(57) ABSTRACT

The present disclosure provides a micro water pump, including: a pump body having a cavity, an inlet communicated with the cavity, and an outlet communicated with the cavity; and a drive mechanism engaged with the pump s body for driving liquid from the inlet into the cavity and discharge from the outlet. The pump body includes a base and an upper cover fixed to the base for cooperatively forming the cavity by ultrasonic welding. By virtue of the configuration, improved heat-dissipation performance is performed.

### FIELD OF THE PRESENT DISCLOSURE

The present disclosure relates to fluid machinery, in particular to a micro water pump.

### DESCRIPTION OF RELATED ART

The heating element of the electronic device generates a large amount of heat during work. If the heat is not discharged in time, the internal temperature of the electronic device will rise sharply, thereby affecting the working efficiency of the electronic components in the electronic device. The use of liquid cooling is a better cooling method. The heating element is connected with the cooling pipeline to absorb the heat emitted by the heating element. The coolant flow in the pipeline drains the high-temperature coolant that absorbs heat and replenishes the low-temperature coolant. In order to accelerate the flow of the cooling liquid, a micro water pump is generally connected to the pipeline, and the flow speed of the cooling liquid is accelerated by the micro water pump.

The related technology water pump comprises an upper cover and a lower cover that are assembled together, and an impeller and magnetic parts installed on the lower cover. The upper cover and the lower cover enclose a accommodating space. The magnetic member drives the impeller to rotate in the receiving space. The impeller rotates under the force of the magnetic field generated by the magnetic member, and the impeller drives the cooling liquid to circulate. However, a sealing ring needs to be provided between the upper cover and the lower cover to seal the containing space, which is complicated in structure. The upper cover and the lower cover are fixed by screws and nuts, the number of parts is large, the cost is high, and the assembly is complicated.

Therefore, it is necessary to research a new type of micro water pump to solve the above problems.

### SUMMARY OF THE PRESENT INVENTION

One of the objects of the present invention is to provide a micro water pump with improved heat-dissipation performance.

To achieve the above-mentioned objects, the present invention provides a micro water pump, comprising: a pump body having a cavity, an inlet communicated with the cavity, and an outlet communicated with the cavity; a drive mechanism engaged with the pump body for driving liquid from the inlet into the cavity and to discharge from the outlet. The pump body comprises a base and an upper cover fixed to the base for cooperatively forming the cavity by ultrasonic welding.

As an improvement, one of the base or the upper cover has a first welding part surrounding the cavity, the other includes a second welding part corresponding to the first welding part; the first welding part and the second welding part are melted into one body by ultrasonic welding for fixing the base and the upper cover.

As an improvement, the first welding part is an annular groove and the second welding part is a circular bump.

As an improvement, the second welding part has a trapezoidal cross-section with an area gradually decreasing toward the first welding part.

As an improvement, the micro water pump includes a rotating shaft formed by the base, wherein the drive mechanism comprises an impeller located in the cavity for being rotatably connected with the rotating shaft, a rotor engaged with the impeller, and a stator mounted on the base for driving the rotor to rotate.

As an improvement, the impeller comprises an impeller body, a first installation slot arranged at one end of the impeller body, and a blade arranged on an outer sidewall of the impeller body; the blade body is rotatably connected with the rotating shaft; and the rotor is a circular magnet installed in the first installation slot.

As an improvement, the rotor is fixed to an inner sidewall of the first installation slot or an outer sidewall of the impeller body by gluing.

As an improvement, a second installation slot is provided on the side of the base back to the upper cover; the stator is embedded in the second installation slot.

As an improvement, the micro water pump further comprises a circuit board installed on the base; a side of the base back to the upper cover is provided with a third installation slot for accommodating the circuit board; the circuit board is electrically connected to the stator via a cable.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is an isometric and exploded view of a micro water pump in accordance with an exemplary embodiment of the present disclosure;

FIG. 2 is an isometric view of a base of the micro water pump shown in FIG. 1;

FIG. 3 is an isometric view of the base in FIG. 2, from another aspect;

FIG. 4 is an isometric view of a cover of the micro water pump shown in FIG. 1;

FIG. 5 is an isometric view of an impeller of the micro water pump shown in FIG. 1;

FIG. 6 is an isometric and assembled view of the micro water pump;

FIG. 7 is cross-sectional view of the micro water pump taken along line AA in FIG. 6;

FIG. 8 is an enlarged view of circled Part B in Fig, 7.

### DETAILED DESCRIPTION OF THE EXEMPLARY EMBODIMENTS

The present disclosure will hereinafter be described in detail with reference to exemplary embodiments. To make the technical problems to be solved, technical solutions and beneficial effects of the present disclosure more apparent, the present disclosure is described in further detail together with the figures and the embodiments. It should be understood the specific embodiments described hereby is only to explain the disclosure, not intended to limit the disclosure.

It should be noted that all directional indicators (such as up, down, left, right, front, back, inside, outside, top, bottom . . . ) in the embodiments of the present invention are only used to explain that they are in a specific posture (As shown in the Fig. below), the relative positional relationship between the components, etc., if the specific posture changes, the directional indication will also change accordingly.

It should also be noted that when an element is referred to as being “fixed on” or “arranged on” another element, the element may be directly on the other element or there may be a centering element at the same time. When an element is referred to as being “connected” to another element, it can be directly connected to the other element or an intermediate element may be present at the same time.

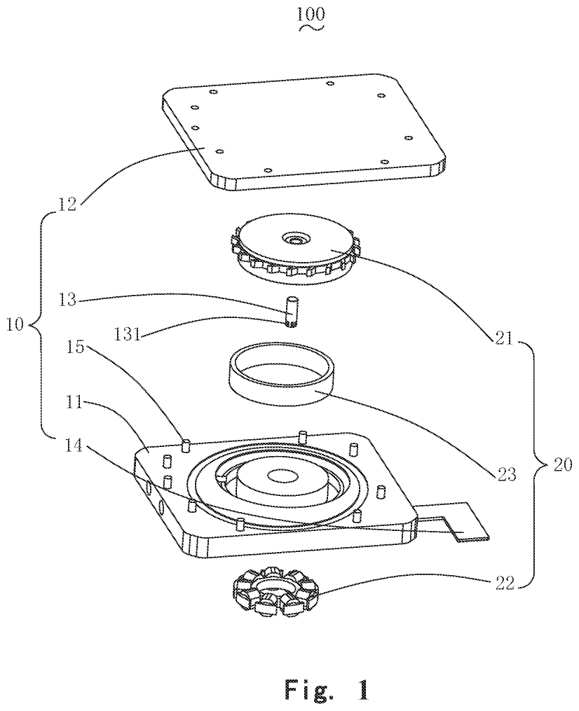

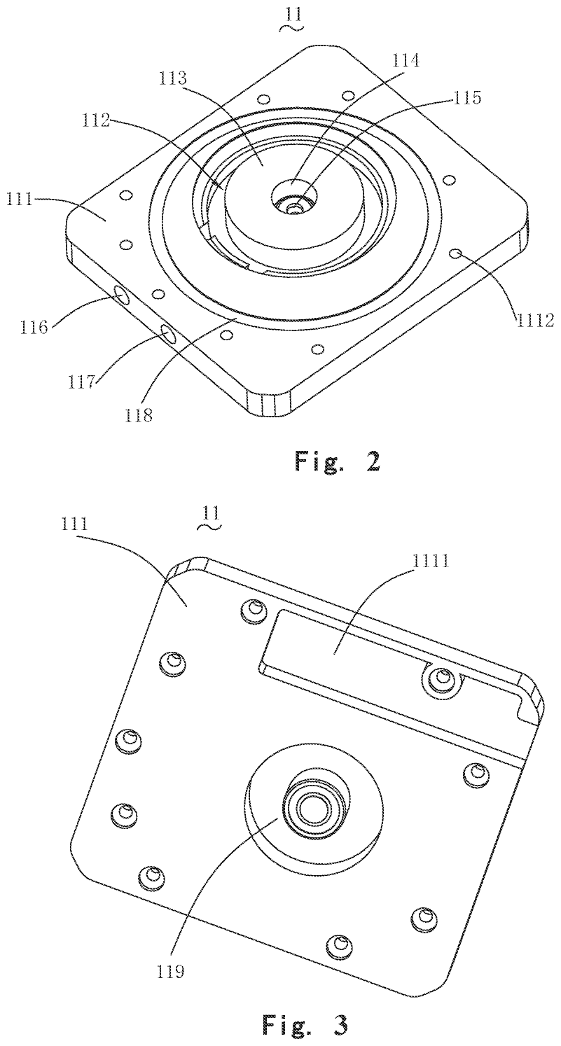

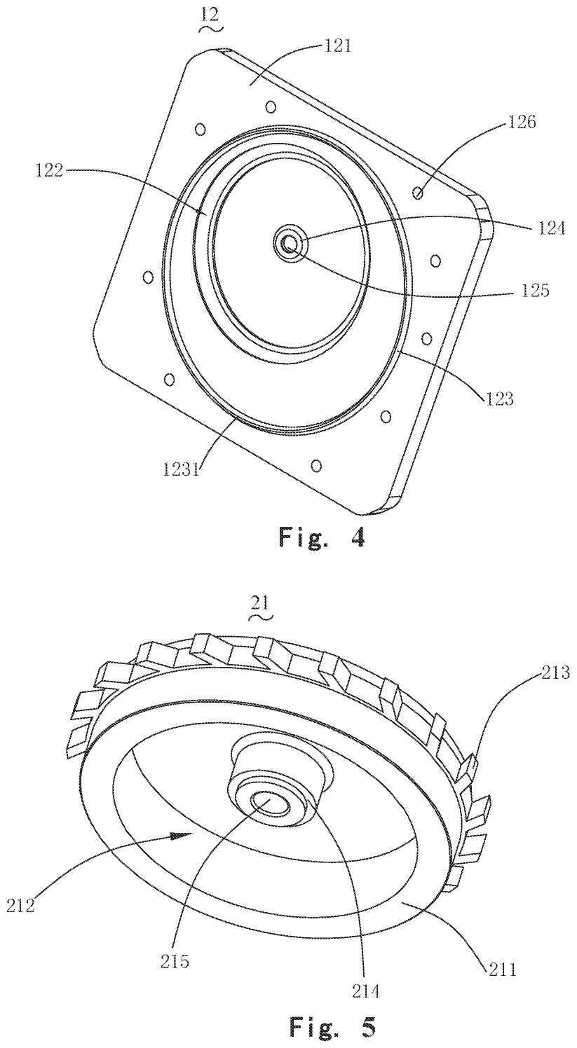

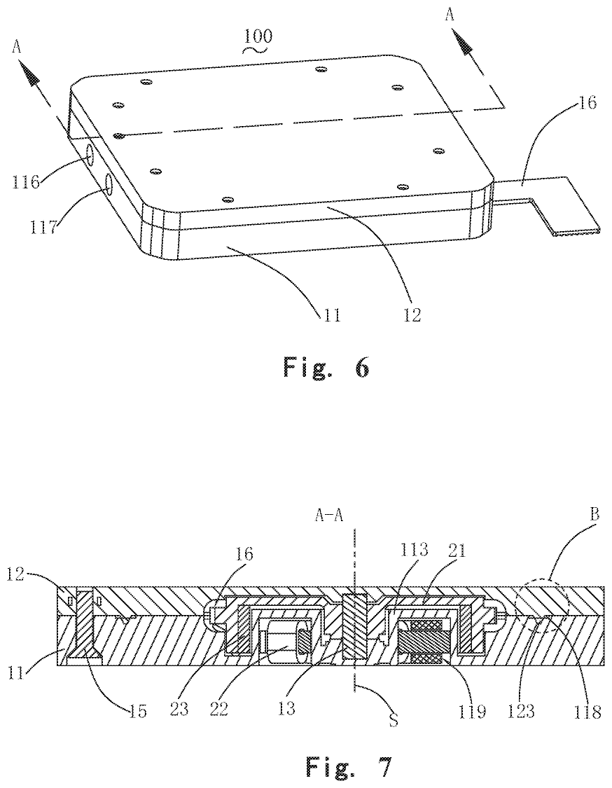

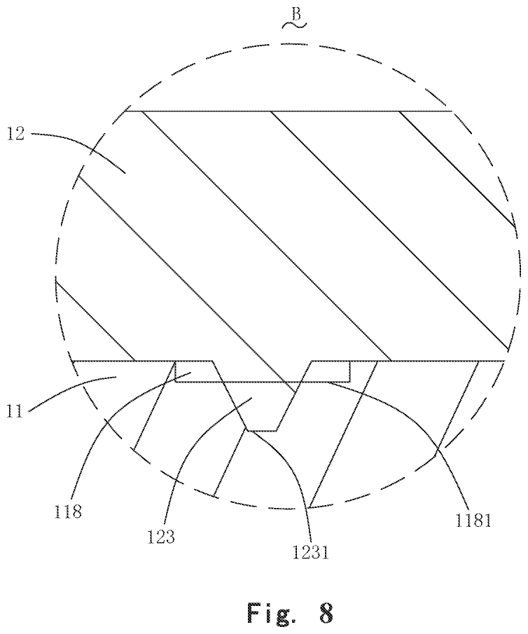

As shown in FIGS. 1-8, an embodiment of the present invention proposes a micro water pump 100, which comprises a pump body 10 and a drive mechanism 20. The pump body 10 is provided with a cavity 16, an inlet 116 connected to the cavity 16, and an outlet 117 connected to the cavity 16. The drive mechanism 20 is installed on the pump body 10 to drive liquid from the inlet 116 into the cavity 16 and discharged from the outlet 117.

Wherein, the pump body 10 comprises a base 11, an upper cover 12 assembled with the base 11, a rotating shaft 13 installed on the base 11, and a circuit board 14 fixed on the outer wall of the base 11. The drive mechanism 20 is electrically connected to the circuit board 14 to control the operation of the drive mechanism 20. The base 11 and the upper cover 12 are assembled to form the cavity 16. The base 11 and the upper cover 12 are fixed together by ultrasonic welding, and the cavity 16 is sealed at the same time. Therefore, the pump body 10 does not need to be provided with a sealing ring to seal the cavity 16, and it is not needed to fix the base 11 and the upper cover 12 with screws and nuts. The number of parts is reduced, and the production cost is reduced; the assembly process is simplified, and the production efficiency is improved.

Specifically, as shown in FIGS. 1-3, the base 11 comprises a square base body 111, a first concave part 112 arranged on the opposite side of the base body 111 and the upper cover 12, a protruding platform 113 protruding from the first concave part 112, a first concave hole 114 provided on the protruding platform 113, a second concave hole 115 provided on the inner bottom wall of the first concave hole 114, a first welding part 118 which is located in the base body 111 and surrounds the first concave part 112, multiple first fixing holes 1112 passing through the base body 111, and a second installation slot 119 and a third installation slot 1111 arranged on the side of the base body 111 away from the upper cover 12.

Wherein, the first concave part 112 and the second installation slot 119 both are in a ring shape, and the inner diameter of the first concave part 112 is larger than the outer diameter of the second installation slot 119, so as to surround the second installation slot 119 therein. The inlet 116 and the outlet 117 are connected to the first concave part 112 respectively. The third installation slot 1111 is a long strip shape, and the circuit board 14 is installed in the third installation slot 1111.

The rotating shaft 13 is approximately cylindrical, and one end of the rotating shaft 13 is fixed in the second concave hole 115 of the base 11. Specifically, the rotating shaft 13 is fixed in the second concave hole 115 by glue bonding. In order to increase the firmness of the bonding between the rotating shaft 13 and the base 11, a plurality of concave pits 131 are provided on the outer periphery of the rotating shaft 13. The concave pit 131 can increase the amount of glue attached to and accommodated by the rotating shaft 13. Therefore, when the glue is solidified, the firmness of the rotating shaft 13 fixed on the base 11 can be strengthened. In other embodiments, the rotating shaft 13 may be formed on the base 11 by over-injection.

The upper cover 12 comprises a cover 121, a second concave part 122 on the side of the cover 121 close to the base 11, a second welding part 123 surrounding the second concave part 122, a convex post 124 arranged on the inner wall of the second concave part 122, a third concave hole 125 provided on the convex post 124 and a plurality of second fixing holes 126 passing through the cover 121. Wherein, the second concave part 122 and the first concave part 112 are arranged correspondingly, and the fixed wall 1221 is arranged opposite to the protruding platform 113.

Wherein, the first welding part 118 is an annular groove formed by sinking on the base 11, which is provided with a trough bottom wall 1181. The second welding part 123 is a circular bump on the side of the upper cover 12 that is close to the base 11 and protrudes toward the base 11. It comprises the end part 1231, the cross section of the second welding part 123 is trapezoidal, and its cross-sectional area gradually decreases toward the first welding part 118, that is, the cross-sectional area of the end part 1231 is the smallest. Optionally, both the first welding part 118 and the second welding part 123 are made of plastic.

Please refer to FIGS. 1-8 together. When the pump body 10 is assembled, the base 11 and the upper cover 12 are assembled together. The end of the rotating shaft 13 away from the base 11 is installed in the third concave hole 125 of the upper cover 12. The first concave part 112 and the second concave part 122 are closed and connected to form the cavity 118.

When fixing the base and the upper cover, the second welding part 123 is embedded in the first welding part 118, and the end part 1231 abuts the rough bottom wall 1181. Under the action of ultrasonic waves, the first welding part 118 and the second welding part 123 vibrate at high frequency and rub against each other. Finally, the first welding part 118 and the second welding part 123 melt to bond the base 11 and the upper cover 12 together. After the first welding part 118 and the second welding part 123 are cured, the base 11 and the upper cover 12 are fixed together. At the same time, the cavity 16 is sealed to form a closed cavity. Since the base 11 and the upper cover 12 are cured together, the cavity 16 is provided with a good sealing effect, no sealing ring is required, and the product structure is simplified. The base 11 and the upper cover 12 do not need to be fixed by screws and nuts, which reduces the number of parts and simplifies the assembly process.

It should be noted that the first welding part 118 is not limited to be provided on the base 11, and the first welding part 118 is also possible to be provided on the upper cover 12. Correspondingly, the second welding part 123 is arranged on the basell.

In order to increase the firmness of fixing the base 11 and the upper cover 12, screws 15 can be used to screw into the first fixing hole 1112 and the second fixing hole 126. In this way, the base body 111 and the cover 121 are further bonded together.

Further, the drive mechanism 20 comprises an impeller 21, which is arranged in the cavity 16, a stator 22 fixed in the second installation slot 119 of the basell, and a rotor 23 fixedly connected to the impeller 21. Specifically, the impeller 21 comprises an impeller body 211 in a cylindrical shape, a first installation slot 212 with a cylindrical shape at one end of the impeller body 211, a blade 213 arranged on the outer sidewall of the impeller body 211, a rotating part 214 protruding from the inner bottom wall of the first installation slot 212, and a shaft hole 215 that penetrates the rotating part 214 and the impeller body 211. The rotor 23 is a ring shape and is fixed to the inner sidewall of the first installation slot 212 or the outer sidewall of the impeller body 211 by gluing. The impeller body 211 and the rotor 23 are wrapped and the protruding platform 113 of the base 11 is accommodated therein. The rotating part 214 is accommodated in the first concave hole 114. The shaft hole 215 is sleeved on the rotating shaft 13 so that the blade body 211 and the rotating shaft 13 are rotatably connected. Optionally, the rotor 22 is a circular magnet.

In other embodiments, the rotor 23 can be fixed to the outer sidewall of the impeller body 211 by gluing.

During the working process of the micro water pump 100, the circuit board 14 passes a variable frequency current to the stator 22. According to the principle of electromagnetic induction, the stator 22 generates rotating magnetic field, and the rotor 23 rotates under the action of ampere force in the rotating magnetic field. The rotating rotor 23 drives the impeller 21 to rotate. The liquid enters the cavity 16 from the inlet 116, and is driven by the impeller 21 to rotate at a high speed and perform centrifugal movement. When the liquid reaches the outlet 117, it is thrown out from the outlet 117. After the liquid is thrown out, the pressure in the cavity 16 decreases and is much lower than the atmospheric pressure. The external fluid is replenished from the inlet 116 into the cavity 16 under the action of atmospheric pressure, and the above-mentioned actions are repeatedly realized to realize the liquid transportation.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A micro water pump, comprising:
a pump body having a cavity, an inlet communicated with the cavity, and an outlet communicated with the cavity;
a drive mechanism engaged with the pump body for driving liquid from the inlet into the cavity and to discharge from the outlet; wherein
the pump body comprises a base and an upper cover fixed to the base for cooperatively forming the cavity by ultrasonic welding.

2. The micro water pump as described in claim 1, wherein one of the base or the upper cover has a first welding part surrounding the cavity, the other includes a second welding part corresponding to the first welding part; the first welding part and the second welding part are melted into one body by ultrasonic welding for fixing the base and the upper cover.

3. The micro water pump as described in claim 2, wherein the first welding part is an annular groove and the second welding part is a circular bump.

4. The micro water pump as described in claim 3, wherein the second welding part has a trapezoidal cross-section with an area gradually decreasing toward the first welding part.

5. The micro water pump as described in claim 1 further including a rotating shaft formed by the base, wherein the drive mechanism comprises an impeller located in the cavity for being rotatably connected with the rotating shaft, a rotor engaged with the impeller, and a stator mounted on the base for driving the rotor to rotate.

6. The micro water pump as described in claim 5, wherein the impeller comprises an impeller body, a first installation slot arranged at one end of the s impeller body, and a blade arranged on an outer sidewall of the impeller body; the blade body is rotatably connected with the rotating shaft; and the rotor is a circular magnet installed in the first installation slot.

7. The micro water pump as described in claim 6, wherein the rotor is fixed to an inner sidewall of the first installation slot or an outer sidewall of the impeller body by gluing.

8. The micro water pump as described in claim 6, wherein a second installation slot is provided on the side of the base back to the upper cover; the stator is embedded in the second installation slot.

9. The micro water pump as described in claim 8, further comprising a circuit board installed on the base; a side of the base back to the upper cover is provided with a third installation slot for accommodating the circuit board; the circuit board is electrically connected to the stator via a cable.
